(19) United States
(12) Patent Application Publication
(10) Pub. No.: US 2005/0261410 A1
(43) Pub. Date: Nov. 24, 2005

(54) Process for lowering the melt viscosity of polyesters

(76) Inventors: Marion G. Waggoner, Landenberg, PA (US); Richard Alan Jackson, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/126,653

(22) Filed: May 10, 2005

Related U.S. Application Data
(60) Provisional application No. 60/573,095, filed on May 21, 2004.

(51) Int. Cl. C08K 3/10

(52) U.S. Cl. 524/437

(57) ABSTRACT

The melt viscosity of polyesters can be reduced by heating the polyester in a melt which is in contact with a hydrate that loses water at the temperature of the process. The process is typically carried out in a polymer melt mixer such as an extruder, and usually a reproducible decrease in the polymer melt viscosity is obtained. The resulting polyesters are useful for making films and moldings.

### CROSS REFERENCE TO RELATED APPLICATIONS

This application claims the benefit of priority of U.S. Provisional Application No. 60/573,095, filed May 21, 2004.

### FIELD OF THE INVENTION

The melt viscosity of polyesters can be lowered by heating, preferably in a melt mixing machine, the polyester with a hydrate whose dehydration temperature is below the temperature of mixing.

### TECHNICAL BACKGROUND

Thermoplastic polyesters, especially semicrystalline polyesters, are useful in many applications, such as films, fibers, and as molding resins, and are important items of commerce. An important property of these polymers is their melt viscosity (which is usually proportional to their molecular weight), which is important when these polymers are melted and then formed into their final or intermediate shape by melt forming. Typically the desired melt viscosity is obtained during the initial polymerization of the polyester, but this means that if different melt viscosity grades of a polyester are desired, they must be manufactured and inventoried separately, an economic disadvantage. Thus a method of reproducibly altering the polyester molecular weight during normal subsequent processing would be desirable.

It is well known that if polyesters are heated to higher temperatures in the presence of water, the molecular weight and hence melt viscosity of the polyester will be reduced. Indeed suppliers of polyesters for films and molding typically suggest that only dry polyesters be melt formed (or the polyester be dried before molding) to avoid undesirable hydrolysis of the polyester with often concomitant degradation of the polymer properties. Controlled reduction of molecular weight by water in typical polymer melt mixers (or other apparatus) such as single and twin screw extruders is difficult or impossible because of the uncontrolled loss of water by vaporization and the immiscibility of water in the polyester.

It has now been found that the melt viscosity (molecular weight) of polyesters can be controllably lowered by adding water to the polyester in the form of a hydrate which will “lose” water at the temperature at which the melt mixer or other apparatus operates. Thus a known amount of hydrate is mixed with a polyester in a melt mixer (or other apparatus) such as a single or twin screw extruder at a temperature high enough to melt the polyester and to cause the hydrate to lose at least some of its water of hydration, and the resulting polyester has a lowered melt viscosity.

### SUMMARY OF THE INVENTION

This invention concerns, a process for lowering the melt viscosity of a polymer, comprising, contacting a polyester in the molten state with a hydrate at a high enough temperature and for a sufficient amount of time to lower a melt viscosity of said polyester by at least about 5 percent, based on the control melt viscosity of said polyester, provided that said temperature is high enough so that said hydrate decomposes to form water.

### DETAILS OF THE INVENTION

Herein certain terms are used, and some of these are defined below:

By a “polyester” herein is meant any polymer in which at least 50% of the linking groups are ester linkages. Preferably at least 80% of the linking groups are ester groups, and more preferably essentially all of the linking groups are ester groups. Thus “polyesters” can include polyester-imides, polyester-amides, polyester-ethers, etc. Included within the definition of an ester (linkage) are esters of carbonic acid, or in other words polymers usually called polycarbonates.

By a “hydrate” is meant a compound that when heated decomposes to form water. The hydrate and its decomposition product(s) (except water) should not adversely significantly affect the polyester.

By a “temperature high enough so that said hydrate decomposes to form water” is meant that at least some of the water that may be liberated from the hydrate by heating is liberated as (free) water at that particular temperature, Not all of the potential water in the hydrate need be liberated. Many hydrates have definite decomposition points at which temperature at least some of their water is liberated.

By “molten state” is meant that a semicrystalline polyester is about or above it melting point, or an amorphous polyester is about or above its glass transition temperature.

Lowering the melt viscosity (see below for the procedure for measuring melt viscosity) by a certain percentage based on a “control” viscosity is calculated by the following formula:
% reduction=[(control viscosity−final viscosity)×100]/control viscosity
“Control viscosity” is the polymer (compound) viscosity after being processed in the same way but without the hydrate, and final viscosity is the viscosity after processing with the hydrate. If the polyester is normally melt processed in a “dry” state, it should preferably be dry (or be dried) before processing, so that the amount of water in the process is known, i.e., the principal source of water is the hydrate.

The temperature chosen for the process will depend on a number of factors, such as the melting or glass transition point of the polyester, decomposition point of the hydrate, desired rate of the hydrolysis (usually higher temperatures give faster rates), the thermal stability of the polyester, etc.

The amount of viscosity reduction for any given hydrate, polyester and set of mixing conditions will be dependent on the particular ingredients used, the temperature and holdup time at that temperature, and the particular conditions of the contacting (mixing). This viscosity reduction is readily determined for any particular process by simple experimentation. Typically about 0.1 to about 2.0 weight percent of a hydrate (based on the amount of polyester present) may be used, but this may vary widely.

Preferably the hydrate is an inorganic hydrate (included within the meaning of inorganic are carbonates). Useful hydrates include metal salts such as halides, hydroxides (but hydrates of strongly basic hydroxides may cause excessive decomposition of the polyester), sulfates, etc., and useful specific hydrates include aluminum trihydrate [Al(OH)₃], CuSO₄.5H₂O, CaCl₂.2H₂O, MgSO₄.7H₂O, and ZnSO₄.7H₂O. A preferred hydrate is aluminum trihydrate. Hydrates that lose all of their water at very low temperatures (for example below the melting point of the polyester and/or when hydrolysis rates are very low) may not be very effective in the process. If some of the water of hydration is freed at very low temperatures and the rest at higher temperatures, only that freed at higher temperatures may be effective. Again simple experimentation will suffice to give guidance.

Generally speaking the more hydrate that is added the more the polyester viscosity will be reduced, all other things being equal (see the examples). However the response of viscosity lowering to amount of hydrate may not be linear. This ability to control the decrease in viscosity is well illustrated in the Examples herein. Preferably the hydrate is added to the process as a relatively fine particulate material, so that it is readily evenly dispersed into the polyester in the melt mixer or other apparatus.

Useful melt mixers include single or twin screw extruders where the hydrate may be side fed or fed with the polyester to the rear zone. If fed with the polyester it may be advantageous to premix the polyester, hydrate and any other ingredients to be added with them, for example by tumbling. Other types of useful melt mixers include kneaders, and sigma blade-type mixers.

The process may be carried out in other types of apparatus. For example polyesters may be finished to a uniform melt viscosity (molecular weight) and then mixed with differing amount of hydrate to lower the melt viscosity to different levels either in a batch polymerization melt finisher or after a continuous finisher, for example by mixing using a static mixer such as a so-called “Kenics®” mixer.

Preferably the polyester is a semicrystalline polyester and/or a melting point of at least about 100° C., more preferably at least about 200° C. By “semicrystalline polyester” means the polyester has a melting point of at least 50° C. with a heat of fusion of at least 3 J/g (except for LCPs).

Polyesters are most commonly derived from one or more dicarboxylic acids and one or more diols. In one preferred type of polyester the dicarboxylic acids comprise one or more of terephthalic acid, isophthalic acid and 2,6-naphthalene dicarboxylic acid, and the diol component comprises one or more of HO(CH₂)ₙOH (I), 1,4-cyclohexanedimethanol, HO(CH₂CH₂O)ₘCH₂CH₂OH (II), and HO(CH₂CH₂CH₂CH₂O)_{z}CH₂CH₂CH₂CH₂OH (III), wherein n is an integer of 2 to 10, m on average is 1 to 4, and z is an average of about 7 to about 40. Note that (II) and (III) may be a mixture of compounds in which m and z, respectively may vary and hence since m and z are averages, they z do not have to be integers. Other diacids which may be used to form the polyester include sebacic and adipic acids. Other diols include a Dianol® {for example 2,2-bis[4-(2-hydroxyethoxy)phenyl]propane available from Seppic, S.A., 75321 Paris, Cedex 07, France} and bisphenol-A. In preferred polyesters, n is 2, 3 or 4, and/or m is 1.

By a “dicarboxylic acid” in the context of a polymerization process herein is meant the dicarboxylic acid itself or any simple derivative such as a diester which may be used in such a polymerization process. Similarly by a “diol” is meant a diol or any simple derivative thereof which can be used in a polymerization process to form a polyester.

Specific preferred polyesters include poly(ethylene terephthalate) (PET), poly(1,3-propylene terephthalate) (PPT), poly(1,4-butylene terephthalate) (PBT), poly(ethylene 2,6-napthoate), poly(1,4-cylohexyldimethylene terephthalate) (PCT), a thermoplastic elastomeric polyester having poly(1,4-butylene terephthalate) and poly(tetramethyleneether)glycol blocks (available as Hytrel® from E. I. DuPont de Nemours & Co., Inc., Wilmington, Del. 19898 USA) and copolymers of any of these polymers with any of the above mentioned diols and/or dicarboxylic acids.

Another type of preferred polyester is a liquid crystalline polymer. By a “liquid crystalline polymer” is meant a polymer that is anisotropic when tested using the TOT test or any reasonable variation thereof, as described in U.S. Pat. No. 4,118,372, which is hereby included by reference. Useful LCPs include polyesters, poly(ester-amides), and poly(ester-imides). One preferred form of polymer is “all aromatic”, that is all of the groups in the polymer main chain are aromatic (except for the linking groups such as ester groups), but side groups which are not aromatic may be present.

The starting polyester may be a “pure” polyester or may be a polyester composition containing other ingredients, particularly those that are commonly added to thermoplastic compositions. Such ingredients include antioxidants, reinforcing agents, pigments, fillers, lubricant, mold release, flame retardants, adhesion promoters, epoxy compounds, crystallization nucleation agents, plasticizers, etc. Other polymers such as polyolefins, and amorphous polymers such as styrene (co)polymers and poly(phenylene oxides) may also be present (in other words polymer blends). Or such materials may be added as the individual (or groups of such) materials to make a final polyester composition containing these materials, or any combination of the foregoing.

In another preferred variation of this process, a small amount of a carboxylic acid is also present. Preferably this compound is polyfunctional such as a di- or tricarboxylic acid. For the amounts and other preferred conditions when adding this type of compound, see U.S. Provisional Patent Application 60/500,087, filed Sep. 4, 2003, and 60/537,539, filed Jan. 20, 2004 (AD7040 US PRV and AD 7040 US PRV.1), which is hereby included by reference.

As noted above, the Examples show a good correlation between the amount of hydrate added and the final melt viscosity achieved. Also in many instances although significant reductions in melt viscosity are obtained, the physical properties measured, especially tensile elongation, do not change much if at all, indicating the polyester compositions still retain good physical properties.

Unless otherwise noted, melting points, glass transition temperatures and heats of fusion are measured by ASTM Method D3418, using a heating rate of 10° C./min. Melting points are taken as the maximum of the melting endotherm, while the glass transition point is taken as the midpoint of the transition, and both are measured on the first heat. If more than one melting point is present the melting point of the polymer is taken as the highest of the melting points.

In the Examples, and for testing purposes, the melt viscosities were and are determined using a Kayness Model 8052 viscometer, Kayness Corp., Morgantown Pa., U.S.A., at a temperature appropriate for that particular polyester (above the melting or glass transition temperature but below the temperature where significant decomposition takes place) and (preferably) a shear rate of 1000/sec.

Tensile modulus, strength and elongation were measured using ASTM Method D256 at an extension rate of 0.508 cm (0.2″) per minute (an extensometer is used to measure elongation). Flexural strength and modulus (three point) were measured using ASTM Method D790.

In the Examples the following abbreviations and materials were used:
ATH—aluminum trihydrate, Grade C-333, from Alcoa World Alumina LLC, Pittsburgh, Pa. 15212 USA.
Crystar® 3934−PET homopolymer, IV=0.67, available from E. I. DuPont de Nemours & Co., Inc., Wilmington, Del. 19898 USA.
Epon® 1009F—epoxy resin available from Resolution Performance Products, Houston, Tex. 77210.
GF—glass fiber, Vetrotex® 991, available from Saint Gobain Vetrotex America, Inc., Valley Forge, Pa. 19482 USA.
Irganox® 1010—antioxidant available from Ciba Specialty Chemicals, Tarrytown, N.Y. 10591, USA.
LCP1—a copolymer made from hydroquinone/terephthalic acid/2,6-naphthalene dicarboxylic acid/4-hydroxybenzoic acid, 100/30/70/150 (molar parts).
Lube—Licowax® PE 190—a polyethylene wax used as a mold lubricant available from Clariant Corp. Charlotte, N.C. 28205, USA.
Plasthall® 809—a plasticizer, polyethylene glycol 400 di-2-ethylhexanoate.
PPG 3563—glass fiber available from PPG Industries, Pittsburgh, Pa. USA
Surlyn® 8920—ethylene/methacrylic acid (85/15 wt. %) copolymer, neutralized with sodium, melt index 0.9 g/10 min, available from E. I. DuPont de Nemours & Co., Inc, Wilmington, Del. 19898, USA.
TiO₂—titanium dioxide, grade Ti-Pure® R100, available from E. I. DuPont de Nemours & Co., Inc, Wilmington, Del. 19898, USA.
Ultranox® 626—an antioxidant, bis(2,4-di-t-butylphenyl)penterythritol diphosphite, available from GE Specialty Chemicals, Inc., Morgantown, W. Va. 26501 USA.

In the Examples, all parts are parts by weight.

### EXAMPLES 1-3 AND COMPARATIVE EXAMPLE A

The ingredients shown in Table 1 were mixed in a 40 mm Werner and Pfleiderer twin screw extruder having 10 barrel sections. The front (discharge) barrel sections and the die were set to 360° C., and the other barrels were set to 330° C. All of the ingredients were fed at the rear, except for the Vetrotex® 991 which was side fed. The screw speed was 325 rpm, and the approximate dwell time in the extruder was about 40 seconds. The polymer composition on exiting the extruder was cooled and pelletized, and then injection molded into test pieces. Physical properties of the polymer are shown in Table 1. The melt viscosity was determined at 340° C. and 1000 sec⁻¹.

TABLE 1

| | Example | | | |
|---|---|---|---|---|
| Ingredient | A | 1 | 2 | 3 |
| LCP1 | 52.8 | 52.6 | 52.3 | 51.8 |
| TiO₂ | 2.0 | 2.0 | 2.0 | 2.0 |
| Lube | 0.2 | 0.2 | 0.2 | 0.2 |
| ATH | 0.00 | 0.25 | 0.50 | 1.00 |
| Vetrotex ® 991 | 45.0 | 45.0 | 45.0 | 45.0 |
| Melt Viscosity, Pa · s | 64 | 43 | 35 | 19 |
| Tensile Strength, MPa | 114 | 114 | 118 | 118 |
| Tensile Elong., % | 3.6 | 3.4 | 3.2 | 1.2 |
| Flexural Strength, MPa | 134 | 143 | 148 | 154 |
| Flexural Modulus, GPa | 12.7 | 13.3 | 13.8 | 14.2 |

### EXAMPLES 4-5 AND COMPARATIVE EXAMPLE B

The ingredients shown in Table 2 were mixed in a 30 mm Werner and Pfleiderer twin screw extruder having 12 barrel sections. The first two (rear) barrel sections were not heated, the next barrel section was set to 160° C., and the remainder of the barrel sections and the die were set to 300° C. All of the ingredients were fed at the rear, except for the Vetrotex® 991 which was side fed and the Plasthall® 809 which was fed to the front section. The screw speed was 300 rpm, and the approximate dwell time in the extruder was about 65 seconds. The polymer composition on exiting the extruder was cooled and pelletized, and then injection molded into test pieces. Physical properties are also shown in Table 2. The melt viscosity was measured at 280° C. and 1000 sec⁻¹.

TABLE 2

| | Example | | |
|---|---|---|---|
| Ingredient | B | 4 | 5 |
| Crystar ® 3934 | 62.55 | 62.45 | 62.35 |
| Surlyn ® 8920 | 3.85 | 3.85 | 3.85 |
| Irganox ® 1010 | 0.10 | 0.10 | 0.10 |
| Epon ® 1009F | 0.60 | 0.60 | 0.60 |
| Ultranox ® 626A | 0.13 | 0.13 | 0.13 |
| PPG 3563 | 30.00 | 30.00 | 30.00 |
| Plasthall ® 809 | 2.77 | 2.77 | 2.77 |
| ATH | 0.00 | 0.10 | 0.20 |
| Melt Viscosity, Pa · s | 230 | 215 | 195 |
| Tensile Strength, MPa | 154 | 155 | 152 |
| Tensile Elong., % | 2.4 | 2.4 | 2.2 |
| Flexural Strength, MPa | 169 | 169 | 170 |
| Flexural Modulus, GPa | 9.6 | 9.6 | 9.6 |

1. A process for lowering the melt viscosity of a polymer, comprising, contacting a polyester in the molten state with an inorganic hydrate at a high enough temperature and for a sufficient amount of time to lower a melt viscosity of said polyester by at least about 5 percent, based on the control melt viscosity of said polyester, provided that said temperature is high enough so that said hydrate decomposes to form water.

2. The process as recited in claim 1 wherein essentially all of the linking groups are ester groups.

3. The process as recited in claim 1 wherein said hydrate is an inorganic hydrate.

4. The process as recited in claim 3 wherein said hydrate is aluminum trihydrate.

5. The process as recited in claim 1 which is carried out in a single or twin screw extruder.

6. The process as recited in claim 1 wherein said polyester is a semicrystalline polyester with a melting point of at least 100° C.

7. The process as recited in claim 1 wherein the dicarboxylic acid components comprise one or more of terephthalic acid, isophthalic acid and 2,6-naphthalene dicarboxylic acid, and the diol component comprises one or more of HO(CH₂)ₙOH, 1,4-cyclohexanedimethanol, HO(CH₂CH₂O)ₘCH₂CH₂OH, and HO(CH₂CH₂CH₂CH₂O)_{z}CH₂CH₂CH₂CH₂OH, wherein n is an integer of 2 to 10, m on average is 1 to 4, and z is an average of about 7 to about 40.

8. The process as described in claim 7 wherein said polyester is chosen from the group consisting of poly(ethylene terephthalate), poly(1,3-propylene terephthalate), poly(1,4-butylene terephthalate), poly(ethylene 2,6-napthoate), poly(1,4-cylohexyldimethylene terephthalate), and a thermoplastic elastomeric polyester having poly(1,4-butylene terephthalate) and poly(tetramethyleneether)glycol blocks

9. The process as recited in claim 1 wherein said polyester is a liquid crystalline polymer.

10. The process as recited in claim 9 wherein said liquid crystalline polymer is all aromatic.

11. The process as recited in claim 1 wherein a carboxylic acid is also present.
